(19) United States
(12) Patent Application Publication
(10) Pub. No.: US 2008/0290608 A1
(43) Pub. Date: Nov. 27, 2008

(54) High-Pressure Connection and Method for Manufacturing a High-Pressure Connection

(76) Inventors: Armin Glock, Urbach (DE); Juergen Hackenberg, Sachsenheim (DE)

Correspondence Address: RONALD E. GREIGG;GREIGG & GREIGG P.L.L.C., 1423 POWHATAN STREET, UNIT ONE, ALEXANDRIA, VA, 22314, US

(21) Appl. No.: 12/096,515

(22) PCT Filed: Oct. 27, 2006
(86) PCT No.: PCT/EP06/67863

§ 371 Date: Jun. 6, 2008

(30) Foreign Application Priority Data
Dec. 19, 2005 (DE) 10 2005 060 667.9

(51) Int. Cl. F02F 11/00; F02M 55/00; F02M 61/16; F16L 19/02; B23P 25/00

(52) U.S. Cl. 277/592; 29/458

(57) ABSTRACT

The invention relates to a high-pressure connection, such as in a fuel injector, having two sealing faces which bear against one another, and to a method for producing a high-pressure connection of this type. In order to improve the sealing action of a high-pressure connection of this type, at least one of the sealing faces is provided with a partial coating. The partial coating is produced by electroforming.

The invention relates to a high-pressure connection with two sealing surfaces resting against each other. The invention also relates to a method for manufacturing a high-pressure connection of this kind.

### PRIOR ART

The tightness of high-pressure connections can be improved by using milling to recess regions that are not relevant to the seal in order to increase the local contact pressure per unit area. In addition, it is known to use O-rings that are composed of a coated metallic material.

The object of the invention is to improve the tightness of high-pressure connections.

### ADVANTAGES OF THE INVENTION

In a high-pressure connection having two sealing surfaces resting against each other, the object is attained in that at least one of the sealing surfaces is provided with a partial coating. The partial coating achieves a component-specific seal that is suitable for high pressures. In the context of the present invention, the term “partial” means that the coating is provided not over the entire sealing surface, but instead on only a part of the sealing surface. This provides a sealing structure on the sealing surface.

According to a preferred exemplary embodiment of the high-pressure connection, the partial coating contains a plurality of different materials. The different materials can be situated one on top of another and/or next to one another.

In a method for manufacturing an above-described high-pressure connection having two sealing surfaces resting against each other, the object stated above is attained in that the partial coating is produced by means of electrochemical metal deposition. In a preferable use of galvanoforming, an electrochemical metal deposition is executed partially, only in defined regions of the sealing surface. The material to be deposited is tailored to the sealing function and to the base material of the sealing surface.

According to a preferred exemplary embodiment of the method, the lateral dimensions of the partial coating are produced by a photomask through the use of photolithography. Photolithography serves to define the regions in which the electrochemical metal deposition takes place by means of galvanoforming. There are two categories of this: a so-called positive resist and a so-called negative resist. With a negative resist, a resist is cross-linked at the locations that are exposed, preferably to UV light. As a result, the resist at these locations becomes insoluble in a subsequent developing process. With a positive resist, the resist is “destroyed” at the locations that are exposed, preferably to UV light. The resist at these locations is “washed away” in the subsequent developing process. In the context of the present invention, preferably negative resists in the form of film resists are used.

According to another preferred exemplary embodiment of the method, the lateral dimensions of the partial coating are defined by laser beam. The laser beam permits a partial coating of the sealing surface in a simple fashion. In this case, the laser beam can be used to expose the photoresist. However, the laser beam can also be used for selective removal of a mask material.

According to another preferred exemplary embodiment of the method, a photoresist is prefabricated in order to achieve a target geometry. In the prefabrication, the target geometry is produced in the photoresist by means of stamping, cutting, or laser shaping. In this case, a photoresist in the form of a film is used that is the same kind used, for example, in the production of printed circuit boards. For example, the film photoresist is 30 cm wide and over 100 m long. In the context of the present invention, the term prefabrication means that the size of the resist is adapted to the surface to be worked.

According to another preferred exemplary embodiment of the method, the prefabricated photoresist is applied to the sealing surface. Preferably, a film photoresist with a substrate film is used. It is, however, also possible to use a liquid resist.

According to another preferred exemplary embodiment of the method, the photoresist applied to the sealing surface is photostructured in order to define the lateral dimensions of the partial coating. The photostructuring is preferably executed by means of the mask and a light source. The photostructuring can also, however, be executed by selective application of laser beams.

According to another preferred exemplary embodiment of the method, the function of a seal produced by the partial coating is adjusted by means of the material and form of the partial coating. In this case, a relatively soft material, for example, is used to adapt to a predetermined roughness of the sealing surface or to compensate for irregularities in a counterpart surface. A relatively hard material can be used to produce a function of a biting edge, which is pressed into the counterpart surface. A multilayered method with various material combinations can serve to further broaden the properties and function of the seat in virtually any fashion.

### DRAWINGS

Other advantages, defining characteristics, and details of the invention ensue from the following description in which various exemplary embodiments are described in detail in conjunction with the drawings.

FIG. 1 shows a sealing surface of a conventional high-pressure connection and

FIG. 2 shows a sealing surface of a high-pressure connection according to the invention.

### DESCRIPTION OF THE EXEMPLARY EMBODIMENTS

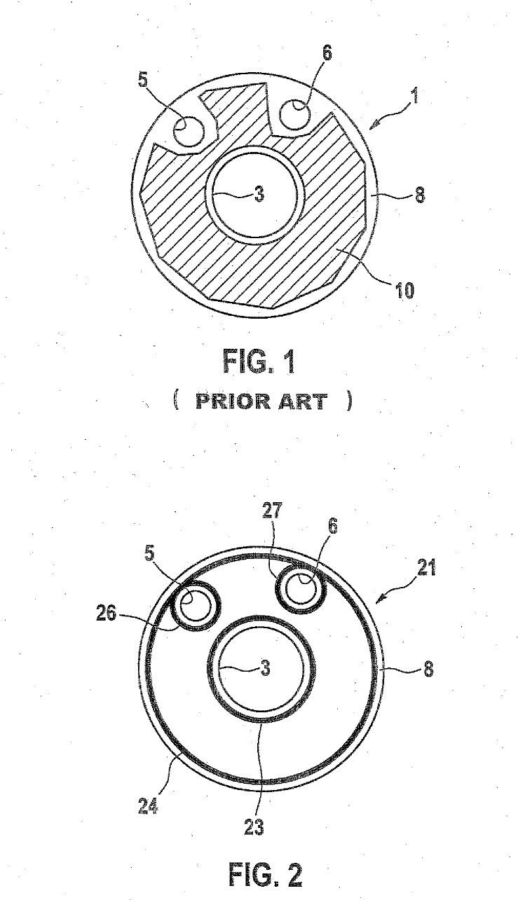

FIG. 1 is a top view of an essentially circular, cylindrical fuel injector body 1. The fuel injector body 1 has a central low-pressure bore 3 as well as a high-pressure bore 5 and an additional low-pressure bore 6 that are both situated radially outside the central low-pressure bore 3. The bores 3, 5, and 6 open out at a common sealing surface 8. In the assembled state, the sealing surface 8 of the fuel injector body 1 comes in contact with the sealing surface of another part (not shown) of a fuel injector. In the assembled state, the two sealing surfaces are clamped snugly against each other in order to produce a pressure-tight connection between the bores 3, 5, and 6 and other bores in the other fuel injector part that are aligned with the bores 3, 5, and 6.

By means of a cross-hatched region 10, FIG. 1 shows that regions not relevant to the sealing function situated between the bores 3, 5, and 6 are recessed. The recessing of the non-sealing-relevant regions 10 increases the local contact pressure per unit area. The recessing of the non-sealing-relevant regions 10 can be achieved by means of milling. The milling, however, is relatively complex and expensive. In addition, the structures that can be produced by means of milling are limited by the milling tool.

FIG. 2 shows a fuel injector body 21 similar to the one shown in FIG. 1. The fuel injector body 21 has a central low-pressure bore 3, a high-pressure bore 5, and an additional low-pressure bore 6. The bores 3, 5, and 6 open out into a sealing service 8 that is embodied in the form of a circular surface.

By contrast with the fuel injector body 1 shown in FIG. 1, in the fuel injector body 21 shown in FIG. 2, regions 23, 24 and 26, 27 that are relevant to the sealing function are raised. The sealing-relevant region 23 is embodied in the form of a circular ring that encompasses the opening of the high-pressure bore 3 in the sealing surface 8. The sealing-relevant region 24 is embodied in the form of a circular ring that is situated concentric to the high-pressure bore 3 and to the sealing-relevant region 23 in the vicinity of the outer circumference of the sealing surface 8. The sealing-relevant regions 26 and 27 are each embodied in the form of a circular ring that encompasses the opening of its respective high-pressure bore 5, 6 in the sealing surface 8.

According to an essential aspect of the present invention, the sealing-relevant regions 23, 24 and 26, 27 are raised in relation to the sealing surface 8. The raising of the sealing-relevant regions 23, 24 and 26, 27 is executed by means of partial coating using the galvanoforming process. The galvanoforming according to the invention is a combination of photolithography and electrochemical metal deposition. The material to be deposited is tailored to the sealing function and base material of the fuel injector body 21. The material spectrum can be set to be anywhere from soft, e.g. indium, to hard, e.g. by means of a nickel-tungsten alloy.

It is also possible to combine a plurality of different materials next to one another or one on top of the other. This provides a large degree of freedom with regard to the sealing geometry to be implemented. Furthermore, the lithography process permits a very high degree of precision. As a result, the seal can be optimally adapted to the component for which the seal is to be provided. The geometry of the seal is laterally defined by a photomask or by a selective direct laser structuring. The height of the seal can be freely established by means of galvanoforming. This makes it possible to achieve seal heights of 0.5 μm to 100 μm. The resist height and the galvanic height must be matched to each other. With high deposition speeds, which are accompanied by high current densities, it is also possible to rapidly manufacture thicker layers.

According to one aspect of the present invention, a prefabricated photoresist with a subsequent photo structuring is used. Preferably, a film resist is used into which the target geometry has been worked by means of stamping, cutting, or laser shaping. In this case, the resist remains on its substrate film or is applied to it after the fabrication. In the context of the present invention, it has turned out to be advantageous to use photoresists in the form of films like the ones used, for example, in printed circuit board production. Such a photoresist is preferably 30 cm wide and over 100 m long. In this context, the term prefabrication means that the size of the resist is adapted to the surface to be worked. A prefabricated resist is similar to a roller with round “stickers.” These stickers precisely fit the entire sealing surface 8 in FIG. 2. Once the “stickers” are applied, the photostructuring of the resist is executed.

The specific sealing structure (23, 24, 26, 27 in FIG. 2) is produced directly on the sealing surface of the component by means of galvanoforming. The method according to the invention for manufacturing the seal is executed as follows. First, the sealing surface (S in FIG. 2) is pretreated, in particular degreased. Then, a prefabricated film resist that is adapted to the component geometry is applied to the sealing surface. The application of the film resist occurs at a predetermined pressure and at a defined temperature. In lieu of a film resist, it is also possible to apply a liquid resist.

In another step of the method, the photostructuring of the resist is carried out. Preferably, the photostructuring is executed by means of a corresponding mask and a light source. The photostructuring can, however, also be applied directly by means of a laser device. Then, the exposed regions are developed, i.e. the resist is partially removed. After this, the regions uncovered in the preceding step are provided with a coating. Finally, the remaining resist is removed. For example, indium is used as the sealing material. When two subassemblies are screwed together, the sealing material flows, closing irregularities and extremely small deviations in form. In so doing, a definite distance from the bores and the outer edges should be maintained.

1-10. (canceled)

11. A high-pressure connection having two scaling surfaces that rest against each other, wherein at least one of the sealing surfaces is provided with a partial coating.

12. The high-pressure connection according to claim 11, wherein the partial coating contains a plurality of different materials.

13. The high-pressure connection according to claim 12, wherein the different materials are applied one on top of the other and/or next to one another.

14. A method for manufacturing a high-pressure connection having two sealing surfaces that rest against each other, comprising the steps of providing a partial coating on at least one of the sealing surfaces, wherein the partial coating is produced by means of electrochemical metal deposition.

15. The method according to claim 14, wherein the partial coating contains a plurality of different materials.

16. The method according to claim 15, wherein the different materials are applied one on top of the other and/or next to one another.

17. The method according to claim 14, wherein lateral dimensions of the partial coating are produced by means of photolithography using a photomask.

18. The method according to claim 15, wherein lateral dimensions of the partial coating are produced by means of photolithography using a photomask.

19. The method according to claim 16, wherein lateral dimensions of the partial coating are produced by means of photolithography using a photomask.

20. The method according to claim 14, wherein lateral dimensions of the partial coating are defined by means of laser beam.

21. The method according to claim 15, wherein lateral dimensions of the partial coating are defined by means of laser beam.

22. The method according to claim 16, wherein lateral dimensions of the partial coating are defined by means of laser beam.

23. The method according to claim 14, wherein a photoresist is prefabricated in order to produce a target geometry.

24. The method according to claim 17, wherein a photoresist is prefabricated in order to produce a target geometry.

25. The method according to claim 20, wherein a photoresist is prefabricated in order to produce a target geometry.

26. The method according to claim 23, wherein the prefabricated photoresist is applied to the sealing surface.

27. The method according to claim 24, wherein the prefabricated photoresist is applied to the sealing surface.

28. The method according to claim 25, wherein the prefabricated photoresist is applied to the sealing surface.

29. The method according to claim 26, wherein the photoresist applied to the sealing surface is photostructured in order to define the lateral dimensions of the partial coating.

30. The method according to claim 14, wherein the function of a seal produced by means of the partial coating is adjusted by means of the material and form of the partial coating.
